(19) United States
(12) Patent Application Publication
(10) Pub. No.: US 2009/0068308 A1
(43) Pub. Date: Mar. 12, 2009

(54) METHOD FOR CREATING ETHANOL-CONTAINING BEVERAGES

(75) Inventors: Daniel Martin Watson, Driftwood, TX (US); Billie Sunday Watson, Wimberly, TX (US)

Correspondence Address: BUSKOP LAW GROUP, P.C., 4511 Dacoma Street, HOUSTON, TX, 77092, US

(73) Assignee: Daniel Martin Watson, Driftwood, TX (US)

(21) Appl. No.: 11/850,795

(22) Filed: Sep. 6, 2007

(51) Int. Cl. C12G 3/07

(52) U.S. Cl. 426/11

(57) ABSTRACT

A method of creating an aged, collectable ethanol-containing beverage comprising the steps of: selecting at least one wood piece useful in imparting at least one flavor component to an ethanol-containing beverage; inserting the at least one wood piece in a container holding the ethanol-containing beverage; permitting the ethanol-containing beverage to age in the container with the at least one wood piece; and retaining the at least one wood piece in the container with the ethanol-containing beverage, forming a continuously aging, collectable ethanol-containing beverage with improved flavor.

### FIELD

The present embodiments relate to a method of creating an aged, collectable ethanol-containing beverage.

### BACKGROUND

A need exists for an ethanol-containing beverage that possesses improved flavor.

A need exists for a method of creating ethanol-containing beverages with a wide variety of flavors.

A further need exists for an ethanol-containing beverage that continues to age while on a sale shelf or in a consumer's possession, enabling the ethanol-containing beverage to be sold and used as a marketing tool that increases in value as time passes.

A need also exists for an ethanol-containing beverage that is collectable, both due to its value as its age increases, and due to the numerous collectable varieties and flavors that can be created.

The present embodiments meet these needs.

### DETAILED DESCRIPTION OF THE EMBODIMENTS

Before explaining the present embodiments in detail, it is to be understood that the embodiments are not limited to the particular embodiments and that they can be practiced or carried out in various ways.

The present embodiments relate to a method of creating an aged, collectable ethanol-containing beverage.

The present process can create a large variety of ethanol-containing beverages with numerous possible flavors by combining one or more ethanol-containing beverages with one or more varieties of wood, then permitting the ethanol-containing beverage to age with the wood. The wood-containing beverages will continue to age, even on a sale shelf or in a consumer's possession, enabling the ethanol-containing beverages to be used as collectable marketing tools that increase in value as time passes.

The embodied ethanol-containing beverages possess improved flavor, and the large variety of possible combinations of ethanol-containing beverages, wood types, wood preparation methods, and other flavor components such as herbs, flowers, fruits, and vegetables creates a collectable series of beverages, all of which continuously age due to the presence of wood in the container.

The embodied process can also include additional marketable, collectable features such as unique containers or distinctly shaped wood pieces that can be removed through an opening in the container.

The process begins by selecting one or more wood pieces useful in imparting one or more flavor components to an ethanol-containing beverage.

The selected one or more wood pieces are inserted into a container holding an ethanol-containing beverage.

The ethanol-containing beverage is then permitted to age in the container with the one or more wood pieces.

The one or more wood pieces are then retained in the container with the ethanol-containing beverage, forming a continuously aging, collectable ethanol-containing beverage with improved flavor.

The characteristics of the continuously aging, collectable ethanol-containing beverage with improved flavor can be selectively manipulated through changing the temperature, pressure, and length of time for which the ethanol-containing beverage is permitted to age. The speed of the aging process can also be increased through selectively manipulating the temperature and pressure at which the ethanol-containing beverage and the one or more wood pieces are permitted to age.

The characteristics of the continuously aging, collectable ethanol-containing beverage with improved flavor can also be manipulated through the type of wood selected, the type of ethanol-containing beverage selected, the preparation and form of the wood, and the use of additional flavorings.

The wood pieces can be any type of wood, including but not limited to oak, maple, hickory, mesquite, cherry, apple, pecan, alder, guava, almond, peach, apricot, acacia, ash, birch, cottonwood, lemon, lilac, mulberry, nectarine, orange, pear, plum, walnut, cedar, pine, grapefruit, lime, chestnut, sycamore, and combinations thereof.

The wood pieces can also be one or more pieces of bark, one or more whole nut shells, one or more pieces of nut shell, one or more pieces of coconut shell, one or more nuts, and combinations thereof. Nuts or nut shells could include peanuts, pecans, walnuts, chestnuts, cocoa nuts, other nuts, and combinations thereof.

The one or more selected wood pieces can have any form, including powder, sticks, chunks, chips, or combinations thereof. It is also contemplated that the wood pieces could be provided with a distinct shape, such as fish, stars, one or more individuals' names, a worm shape, a geometrical shape, and other shapes. The one or more wood pieces can be sized such that they are able to fit through an opening in the container.

In an embodiment, the wood pieces can also be from a used cask for holding wine or ethanol-containing beverages.

It is also contemplated that the ethanol-containing beverage can be provided in a container for consumer sales, such as a glass or a polymer container. The glass or polymer container can be a container with a volume of 250 ml, 375 ml, 750 ml, 1 liter, 1.75 liter, or other volumes. The container can be transparent to allow the wood contained within the continuously-aging, collectable ethanol-containing beverage to be visible to a consumer. The container could also be uniquely molded or shaped.

In an embodiment, the container can further comprise a breathable cork stopper or other breathable sealer to allow some oxygen into the container to enhance the continuous aging of collectable ethanol-containing beverage.

The ethanol-containing beverage can be any ethanol-containing beverage including but not limited to a whiskey, a bourbon, a rum, a brandy, an Armagnac, a cognac, a vodka, a tequila, and an eau de vie.

In an embodiment the one or more selected wood pieces can be roasted prior to associating the wood pieces with the ethanol-containing beverage. This can be beneficial due to the fact that the aging process is slower when raw wood is used.

It is also contemplated that the one or more wood pieces can be roasted wood, charred wood, dehydrated wood, dried wood, raw wood, or combinations thereof.

The roasting of the selected one or more wood pieces can be performed by flash roasting. The flash roasting can have a flame temperature in excess of 2000 degrees Fahrenheit.

The roasting can also be performed for up to eight hours at a temperature ranging from about 180 degrees Fahrenheit to about 220 degrees Fahrenheit. In other embodiments, the roasting can be performed at 380 degrees Fahrenheit for a time period ranging from two hours to four hours, or at a temperature of 460 degrees Fahrenheit for a time period ranging from one half hour to one hour.

The one or more selected wood pieces can also comprise additional flavoring, such as vegetable oils, nut oils, fruit extracts, vegetable extracts, spices, or other flavorings disposed therein.

In an embodiment, the method can further comprise the addition of a small amount of a fruit, a vegetable, a flower, a herb, a spice, or combinations thereof. The fruit, the vegetable, the flower, the herb, the spice, or any combination thereof can be roasted, dehydrated, fresh, dried, or combinations thereof.

The present embodiments also relate to a beverage produced using the embodied method.

The beverage comprises an ethanol-containing beverage, such as a whiskey, a bourbon, a rum, a brandy, an Armagnac, a cognac, a vodka, a tequila, or an eau de vie, that has been permitted to age in the container, with one or more selected wood pieces.

The present embodiments also relate to a marketing tool comprising a continually aging beverage prepared using the embodied method. The ethanol-containing beverage containing one or more selected wood pieces can be used as a marketing tool because the ethanol-containing beverage continues to mature in a container, whether on a sale shelf, or in a consumer's possession, creating a product that increases in value as time passes.

Due to the wide variety of ethanol-containing beverages, types of wood, wood preparation methods, and additional flavorings that can be used, an entire series of collectable, continuously-aging marketing tools that increase in value as time passes can be created and collected.

Select containers for consumer sale can be used, such as containers with unique sizes, shapes, or materials. Select wood pieces can also be used, such as uniquely shaped wood pieces, or uniquely sized wood pieces able to fit through an opening in the container. Select corks, stoppers, labels, and other items can be used to further enhance the appearance and commercial appeal of the continuously-aging, collectable ethanol-containing beverage with improved flavor.

While these embodiments have been described with emphasis on the embodiments, it should be understood that within the scope of the appended claims, the embodiments might be practiced other than as specifically described herein.

1. A method of creating an aged, collectable ethanol-containing beverage comprising the steps of:
(a) selecting at least one wood piece useful in imparting at least one flavor component to an ethanol-containing beverage;
(b) inserting the at least one wood piece in a container holding the ethanol-containing beverage;
(c) permitting the ethanol-containing beverage to age in the container with the at least one wood piece; and
(d) retaining the at least one wood piece in the container with the ethanol-containing beverage, forming a continuously aging, collectable ethanol-containing beverage with improved flavor.

2. The method of claim 1, wherein the ethanol-containing beverage is selected from the group consisting of: a whiskey, a bourbon, a rum, a brandy, an Armagnac, a cognac, a vodka, a tequila, and an eau de vie.

3. The method of claim 1, wherein the at least one wood piece is selected from the group consisting of: oak, maple, hickory, mesquite, cherry, apple, pecan, alder, guava, almond, peach, apricot, acacia, ash, birch, cottonwood, lemon, lilac, mulberry, nectarine, orange, pear, plum, walnut, cedar, pine, grapefruit, lime, chestnut, sycamore, and combinations thereof.

4. The method of claim 1, further comprising roasting the at least one wood piece prior to associating the at least one wood piece with the ethanol-containing beverage.

5. The method of claim 1, wherein the at least one wood piece comprises a member of the group: roasted wood, charred wood, dehydrated wood, dried wood, raw wood, or combinations thereof.

6. The method of claim 4, wherein the roasting of the at least one wood piece is flash roasting.

7. The method of claim 6, wherein the flash roasting has a flame temperature in excess of 2000 degrees Fahrenheit.

8. The method of claim 4, wherein the roasting of the wood is performed for up to eight hours at a temperature from about 180 degrees Fahrenheit to about 220 degrees Fahrenheit.

9. The method of claim 1, wherein the container comprises a breathable cork stopper or other breathable sealer to allow some oxygen to enter the container to enhance aging.

10. The method of claim 1, wherein the at least one wood piece is in the form of powder, sticks, chunks, chips, or combinations thereof.

11. The method of claim 1, wherein the at least one wood piece is from a used cask for holding wine or ethanol-containing beverages.

12. The method of claim 1, wherein the container is a glass or a polymer container for consumer sales adapted to contain at least a member of the group: 250 ml, 375 ml, 750 ml, 1 liter, or 1.75 liter.

13. The method of claim 1, wherein the at least one wood piece has a distinct shape.

14. The method of claim 1, wherein the at least one wood piece is sized to fit though an opening in the container.

15. The method of claim 1, where the at least one wood piece comprises at least one additional flavoring disposed therein.

16. The method of claim 1, wherein the at least one wood piece comprises a member of the group: at least one piece of bark, at least one whole nut shell, at least one piece of nut shell, at least one piece of coconut shell, at least one nut, and combinations thereof.

17. The method of claim 1, further comprising inserting into the container a small amount of: a fruit, a vegetable, a flower, a herb, a spice, or combinations thereof.

18. The method of claim 17, wherein the fruit, the vegetable, the flower, the herb, the spice, or combinations thereof is roasted, dehydrated, fresh, dried, or combinations thereof.

19. A continuously-aging, ethanol-containing beverage made by the method of claim 1.

20. A marketing tool comprising a continuously-aging, ethanol-containing beverage prepared by the method of claim 1.
